(19) United States
(12) Patent Application Publication
(10) Pub. No.: US 2020/0039230 A1
(43) Pub. Date: Feb. 6, 2020

(54) INK JET PRINTER

(71) Applicant: Roland DG Corporation, Hamamatsu-shi (JP)

(72) Inventors: Bunji SHINOMIYA, Hamamatsu-shi (JP); Yuichi SUGIYAMA, Hamamatsu-shi (JP)

(21) Appl. No.: 16/520,383

(22) Filed: Jul. 24, 2019

(30) Foreign Application Priority Data
Jul. 31, 2018 (JP) 2018-144551

(51) Int. Cl. B41J 2/165; B41J 29/38

(52) U.S. Cl. CPC B41J 2/16538; B41J 29/38; B41J 2/16544

(57) ABSTRACT

An ink jet printer includes an ink head with a nozzle surface, a cleaner assembly including a cleaner that contacts the nozzle surface, a conveyor that moves the ink head and the cleaner assembly relative to each other, and a controller. The nozzle surface includes a first end in a first direction, and a second end in a second direction. The controller brings the cleaner into contact with a portion of the nozzle surface ahead of the first end in the second direction, and then moves the cleaner in the second direction while keeping the cleaner in contact with the nozzle surface. Thereafter, the controller moves the cleaner away from the nozzle surface. In addition, the controller brings the cleaner into contact with a portion of the nozzle surface ahead of the second end in the first direction, and then moves the cleaner in the first direction while keeping the cleaner in contact with the nozzle surface.

### CROSS REFERENCE TO RELATED APPLICATIONS

This application claims the benefit of priority to Japanese Patent Application No. 2018-144551 filed on Jul. 31, 2018. The entire contents of this application are hereby incorporated herein by reference.

### BACKGROUND OF THE INVENTION

### 1. Field of the Invention

The present disclosure relates to an ink jet printer.

### 2. Description of the Related Art

An ink jet printer known to date includes a wiping mechanism for removing ink and other substances attached to ink heads. JP H07-125228 A, for example, discloses an ink jet recording device including a wiping member (blade) that slidably contacts discharge faces of a plurality of recording heads and wipes ink and other substances.

In such wiping, if ink smudges or other foreign substances are present outside a nozzle region where nozzles of ink heads are formed, a wiper might bring the smudges or other substances into the nozzle region. When such a smudge or other substances enters nozzles, problems such as a failure in discharging ink might occur. As described above, typical head cleaning techniques have not always achieved high quality.

### SUMMARY OF THE INVENTION

Preferred embodiments of the present invention provide ink jet printers each capable of performing high-quality head cleaning.

An ink jet printer according to a preferred embodiment of the present invention includes an ink head including a nozzle surface provided with a plurality of nozzles, a cleaner assembly including a cleaner to contact the nozzle surface, a conveyor that moves the ink head and the cleaner assembly relative to each other, and a controller that controls the conveyor. The nozzle surface includes a first end in a first direction, and a second end in a second direction opposite to the first direction. The controller includes a first controller, a second controller, a third controller, a fourth controller, and a fifth controller. The first controller performs a first step of bringing the cleaner into contact with a portion of the nozzle surface ahead of the first end in the second direction. The second controller performs, after the first step, a second step of moving the cleaner relative to the ink head in the second direction while keeping the cleaner in contact with the nozzle surface. The third controller performs, after the second step, a third step of moving the cleaner away from the nozzle surface. The fourth controller performs, after the third step, a fourth step of bringing the cleaner into contact with a portion of the nozzle surface ahead of the second end in the first direction. The fifth controller performs, after the fourth step, a fifth step of moving the cleaner relative to the ink head in the first direction while keeping the cleaner in contact with the nozzle surface.

In the ink jet printer, the cleaner is first brought into contact with the nozzle surface to partially overlap the nozzle surface, and then, from this position, is moved toward the outside of the nozzle surface. Thus, smudges outside a nozzle region where the nozzles are provided on the nozzle surface are not brought into the nozzle region. Accordingly, higher quality head cleaning is able to be performed.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a front view of a printer according to a preferred embodiment of the present invention.

FIG. 2 is a plan view of a table.

FIG. 3 is a plan view schematically illustrating a configuration of a carriage lower surface.

FIG. 4A is a perspective view of a cleaner assembly.

FIG. 4B illustrates a state where an absorption member, a sheet holding member, and a fourth leg are removed from the state illustrated in FIG. 4A.

FIG. 5 schematically illustrates an example of leg portions.

FIG. 6 is a flowchart depicting a cleaning operation of a first ink head.

FIG. 7A schematically illustrates a positional relationship among the first ink head, a first cleaner, and a second cleaner in step S11.

FIG. 7B schematically illustrates a positional relationship among the first ink head, the first cleaner, and the second cleaner in step S12.

FIG. 7C schematically illustrates a positional relationship among the first ink head, the first cleaner, and the second cleaner in step S20.

FIG. 7D schematically illustrates a positional relationship among the first ink head, the first cleaner, and the second cleaner in step S30.

FIG. 7E schematically illustrates a positional relationship among the first ink head, the first cleaner, and the second cleaner in a sliding operation.

FIG. 7F schematically illustrates a positional relationship among the first ink head, the first cleaner, and the second cleaner in step S41.

FIG. 7G schematically illustrates a positional relationship among the first ink head, the first cleaner, and the second cleaner in step S42.

FIG. 7H schematically illustrates a positional relationship among the first ink head, the first cleaner, and the second cleaner in step S50.

FIG. 8 is a plan view schematically illustrating a positional relationship between a carriage and a cleaner assembly at the time of step S20.

FIG. 9 is a side view schematically illustrating a cleaner assembly according to a first variation of a preferred embodiment of the present invention.

FIG. 10 is a plan view schematically illustrating a first ink head and a cleaner assembly according to a second variation of a preferred embodiment of the present invention.

FIG. 11 is a perspective view of a cleaner assembly according to a third variation of a preferred embodiment of the present invention.

### DETAILED DESCRIPTION OF THE PREFERRED EMBODIMENTS

Cleaning systems of ink jet printers according to preferred embodiments of the present invention will be described hereinafter with reference to the drawings. The preferred embodiments described here are, of course, not intended to particularly limit the present disclosure. Elements and features having the same functions are denoted by the same reference numerals, and description for the same members and components will not be repeated or will be simplified as appropriate. In the following description, when the ink jet printer is seen from the front, a direction away from the ink jet printer will be referred to as forward, and a direction toward the ink jet printer will be referred to as rearward. Characters F, Rr, L, R, U, and D in the drawings represent front, rear, left, right, up, and down, respectively. It should be noted that these directions are defined simply for convenience of description, and do not limit the state of installation of the ink jet printer, for example.

Character Y represents main scanning directions in the drawings. The main scanning directions Y are left-right directions. In the following description, one of the main scanning directions Y will be referred to as a first main scanning direction Y1, and the other will be referred to as a second main scanning direction Y2. In this preferred embodiment, the first main scanning direction Y1 is a leftward direction. The second main scanning direction Y2 is a rightward direction. Character X represents sub-scanning directions. The sub-scanning directions X are front-rear directions. The main scanning directions Y and the sub-scanning directions X are orthogonal to each other in plan view. In the following description, one of the sub-scanning directions X will be referred to as a first sub-scanning direction X1, and the other will be referred to as a second sub-scanning direction X2, when necessary. In this preferred embodiment, the first sub-scanning direction X1 is a forward direction. The second sub-scanning direction X2 is a rearward direction. Character Z represents top-bottom directions. The top-bottom directions Z are orthogonal to the main scanning directions Y and the sub-scanning directions X. It should be noted that the main scanning directions Y, the sub-scanning directions X, and the top-bottom directions Z are not limited to specific directions, and may be appropriately defined in accordance with the state of a printer 10.

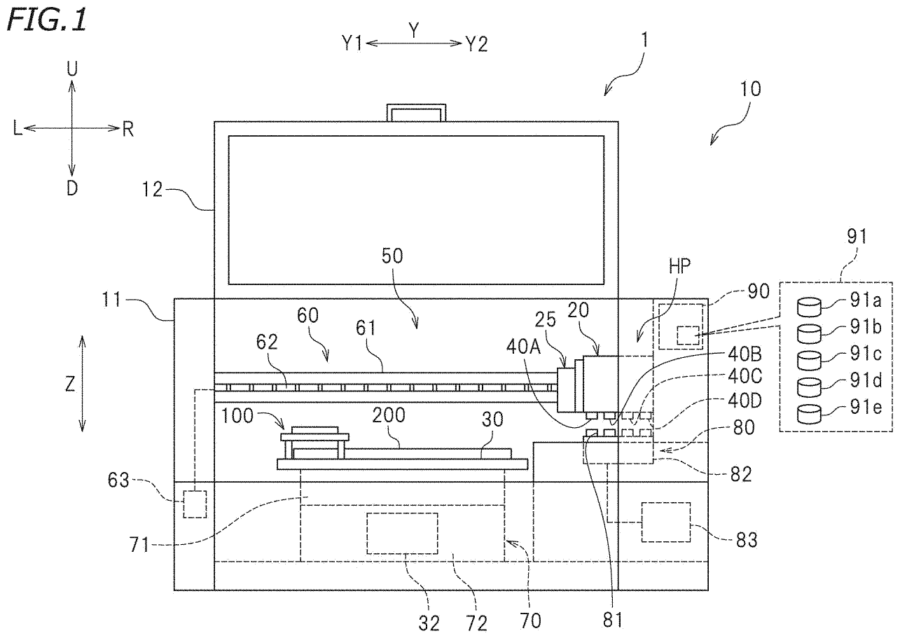

As illustrated in FIG. 1, a cleaning system 1 according to this preferred embodiment includes the printer 10 and a cleaner assembly 100. The cleaning system 1 is a system that cleans ink heads 40A through 40D of the printer 10 using the cleaner assembly 100. The cleaner assembly 100 is detachably attached to a table 30. In this preferred embodiment, the cleaner assembly 100 constitutes the cleaning system 1 together with the printer 10. Alternatively, the cleaner assembly 100 may be a detachable member of the printer 10.

The printer 10 includes a printer body 11, a carriage 20, the plurality of ink heads 40A through 40D mounted on the carriage 20, a conveyor 50, a capping device 80, and a controller 90.

The printer body 11 has a box shape that is open at the front. The printer body 11 extends in the left-right directions. The printer body 11 houses, therein, the carriage 20, the table 30, the ink heads 40A through 40D, the conveyor 50, the capping device 80, and the controller 90. The printer body 11 includes a front cover 12 capable of opening and closing the front open area.

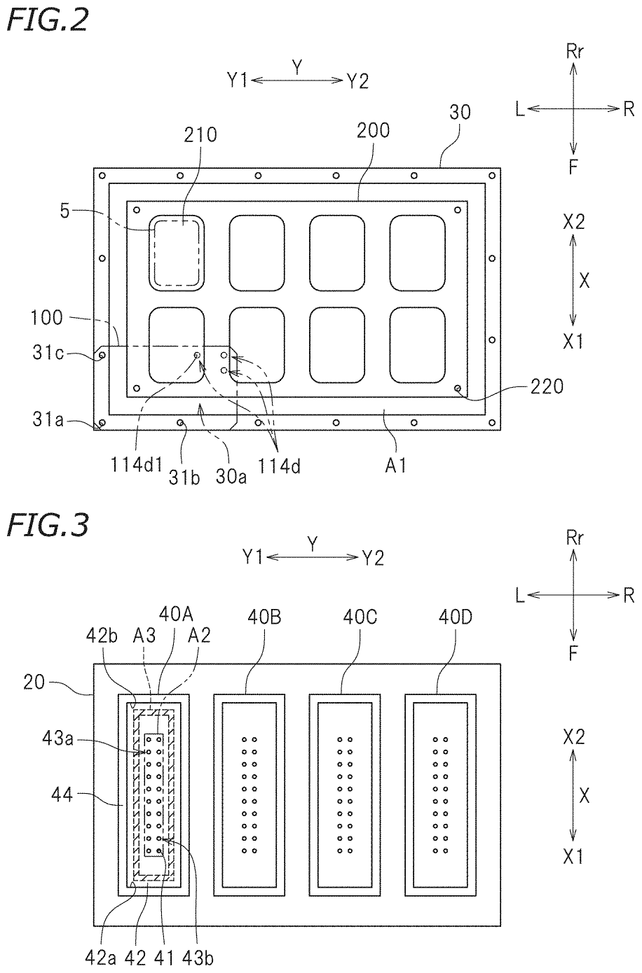

As illustrated in FIG. 1, the table 30 is disposed substantially at the center of internal space of the printer body 11 in the main scanning directions Y. The table 30 is placed substantially horizontally. The table 30 is a member on which a print object 5 (see FIG. 2) is placed. The printer 10 according to this preferred embodiment is a so-called flat-bed type printer, for example.

FIG. 2 is a plan view of the table 30. In FIG. 2, the cleaner assembly 100 is indicated by chain double-dashed lines. As illustrated in FIG. 2, a jig 200 to position the print object 5 is placed on the table 30. The shape of the print object 5 is not limited to a specific shape, and may be various three-dimensional shapes as well as the flat plate shape. The material for the print object 5 is not limited to a specific material, and the print object 5 may be, for example, wood, metal, glass, paper, or cloth. As illustrated in FIG. 2, a plurality of print objects 5 may be used. The plurality of print objects 5 are respectively placed in housings 210 of the jig 200. The housings 210 here are through holes formed in flat shapes corresponding to the print objects 5. The print objects 5 are placed in the housings 210 to be positioned relative to the table 30. The jig 200 has a uniform or substantially uniform thickness. The jig 200 is preferably made of a material having a standardized thickness. The thickness of the jig 200 preferably is about 3 mm or about 6 mm, for example. The jig 200 is made of ABS, for example.

As illustrated in FIG. 2, the table 30 includes a print area A1 that is a maximum printable area. The jig 200 here is disposed inside the print area A1. Although not shown, the print area A1 of the table 30 includes a plurality of screw holes. The jig 200 is fixed to the table 30 with bolts 220 using these screw holes. Although not shown, the table 30 includes a plurality of through holes. As illustrated in FIG. 1, a fan 32 is disposed under the table 30. The fan 32 is driven to eject air from space under the table 30 so that a negative pressure is generated in the space under the table 30. This negative pressure causes the print object 5 to be adsorbed on the table 30 through the plurality of through holes.

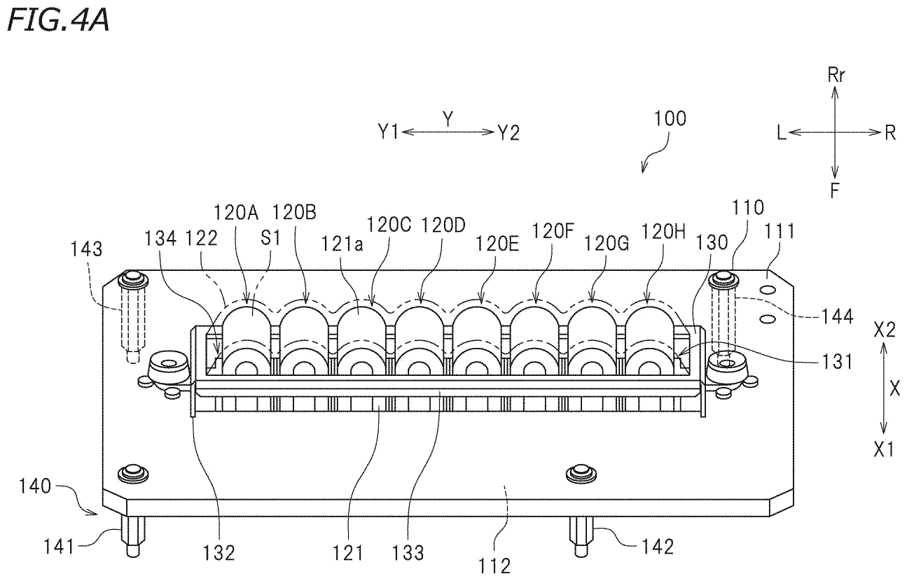

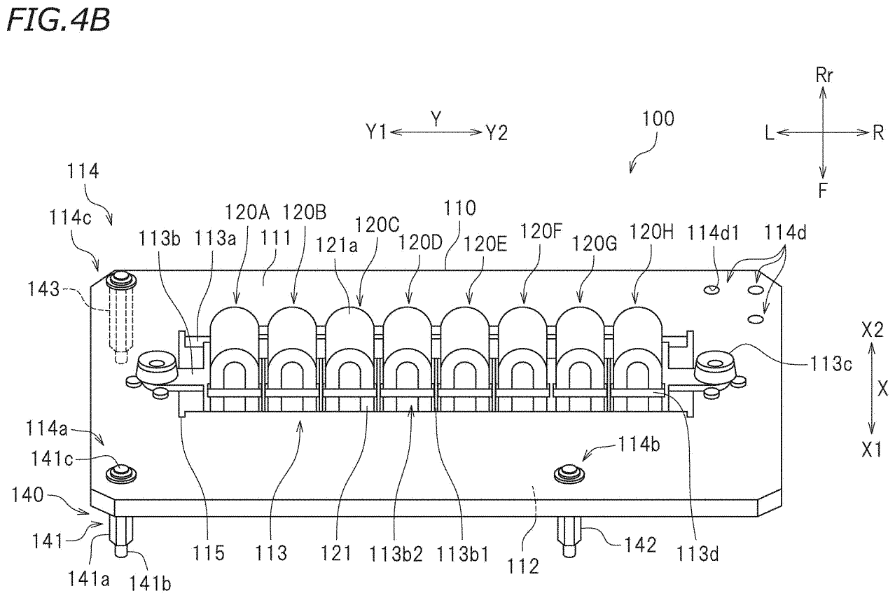

As illustrated in FIG. 2, the table 30 includes a unit placing area 30a on which the cleaner assembly 100 is placed. The unit placing area 30a is set within a certain area from the left front end of the table 30. The unit placing area 30a includes placement holes 31a through 31c in which legs 141 through 143 (see FIG. 4A) of the cleaner assembly 100 are respectively inserted. The placement holes 31a through 31c define a first positioning mechanism to determine a position at which the cleaner assembly 100 is placed. The placement holes 31a through 31c are through holes penetrating the table 30 in the top-bottom directions Z. The placement holes 31a through 31c are located outside the print area A1 of the table 30. Specifically, the first placement hole 31a is disposed at the left front end of the table 30. The second placement hole 31b is disposed at the front end of the table 30 and at the right of the first placement hole 31a. The third placement hole 31c is disposed at the left end of the table 30 and behind the first placement hole 31a. In this preferred embodiment, three placement holes are provided, but at least two placement holes are sufficient. At least two placement holes can function as a positioning mechanism, for example.

The plurality of ink heads 40A through 40D face the table 30. The ink heads 40A through 40D are mounted on the carriage 20. The carriage 20 are movably engaged with the printer body 11 through a guide rail 61 of the conveyor 50. FIG. 3 is a plan view schematically illustrating a configuration of the lower surface of the carriage 20. As illustrated in FIG. 3, the plurality of ink heads 40A through 40D are arranged along the main scanning directions Y in the carriage 20. Among these ink heads, the first ink head 40A is located at the head in the first main scanning direction Y1 (at the left in this preferred embodiment). The second ink head 40B is located ahead (at the right in this preferred embodiment) of the first ink head 40A in the second main scanning direction Y2. The third ink head 40C is located ahead of the second ink head 40B in the second main scanning direction Y2. The fourth ink head 40D is at the head in the second main scanning direction Y2. Each of the ink heads 40A through 40D extends along the sub-scanning directions X. The ink heads 40A through 40D are aligned along the sub-scanning directions X.

The first ink head 40A includes a nozzle surface 42 provided with a plurality of nozzles 41. Here, the nozzle surface 42 is the lower surface of the first ink head 40A. The nozzles 41 are minute holes from which ink is discharged. Each of the plurality of nozzles 41 is connected to an actuator including a piezoelectric element. When the actuator is driven, each nozzle 41 discharges ink. The actuator includes a pressure chamber that communicates with the nozzle 41 and stores ink, and a piezoelectric element that contacts the pressure chamber. When a voltage applied to the piezoelectric element is changed, the piezoelectric element expands and contracts, and this displacement changes the volume of the pressure chamber. The change in the volume of the pressure chamber causes ink to be discharged from the nozzle 41. The plurality of actuators are electrically connected to the controller 90 and controlled by the controller 90. In the first ink head 40A, the plurality of nozzles 41 are arranged in two nozzle rows 43a and 43b each extending in the sub-scanning directions X. The first nozzle row 43a and the second nozzle row 43b are disposed side by side in the main scanning directions Y.

The nozzle surface 42 of the first ink head 40A includes a nozzle region A2 including all the nozzles 41. As illustrated in FIG. 3, the nozzle region A2 here is a rectangular region defined outside the first nozzle row 43a and the second nozzle row 43b. The nozzle region A2 is an imaginary region including a range where the nozzles 41 are provided and the periphery thereof on the nozzle surface 42. Thus, the nozzle region A2 does not need to include any particular component in addition to the nozzles 41. As illustrated in FIG. 3, a region A3 that contacts caps 81 described later is present outside the nozzle region A2.

The nozzle surface 42 includes an end 42a toward the first sub-scanning direction X1 (hereinafter referred to as a first end 42a as necessary) and an end 42b toward the second sub-scanning direction X2 (hereinafter referred to as a second end 42b as necessary). Here, the first end 42a is the front end of the nozzle surface 42. The second end 42b is the rear end of the nozzle surface 42. A head guard 44 is disposed outside the nozzle surface including the first end 42a and the second end 42b in its boundary. The head guard 44 projects downward from the nozzle surface 42. The head guard 44 prevents collision of an obstacle against the nozzles 41. The boundary between the head guard 44 and the nozzle surface 42 includes a step.

The second ink head 40B through the fourth ink head 40D have the same configuration as that of the first ink head 40A. One ink cartridge (not shown) is connected to each of the nozzle rows of the ink heads 40A through 40D. Ink stored in the ink cartridges connected to the ink heads are discharged from the nozzle rows of the ink heads 40A through 40D. The material for the ink is not limited to a specific material, and various materials conventionally used for ink of ink jet printers may be used. Here, an UV curable pigment ink that cures by ultraviolet rays is used.

As illustrated in FIG. 1, the carriage 20 is provided with an ultraviolet lamp 25. Here, the ultraviolet lamp 25 is disposed at the left side surface of the carriage 20. The ultraviolet lamp 25 extends in the sub-scanning directions X. The ultraviolet lamp 25 irradiates the table 30 with ultraviolet rays. The ultraviolet lamp 25 is electrically connected to the controller 90 and controlled by the controller 90.

The conveyor 50 moves the ink heads 40A through 40D and the table 30 relative to each other. The conveyor 50 according to this preferred embodiment includes a carriage conveyor 60 and a table conveyor 70. The carriage conveyor 60 moves the carriage 20 in the main scanning directions Y. The main scanning directions Y are parallel to the table 30. The carriage conveyor 60 includes a guide rail 61, a belt 62, unillustrated left and right pulleys, and a scanning motor 63. The carriage 20 is slidably engaged with the guide rail 61. The guide rail 61 is fixed to the printer body 11 and extends in the left-right directions. The guide rail 61 guides movement of the carriage 20 in the left-right directions. The belt 62 is fixed to the carriage 20. The belt 62 is an endless belt. The belt 62 is wound around unillustrated pulleys at the left and right of the guide rail 61. The scanning motor 63 is attached to one of the pulleys. The scanning motor 63 is electrically connected to the controller 90. The scanning motor 63 is controlled by the controller 90. When the scanning motor 63 is driven, the pulleys rotate so that belt 62 runs. Accordingly, the carriage 20 moves in the left-right directions along the guide rail 61.

The table conveyor 70 is disposed under the table 30. The table conveyor 70 moves the table 30 in the sub-scanning directions X and the top-bottom directions Z. The table conveyor 70 supports the table 30 from the bottom. The table conveyor 70 includes a Z-axis moving mechanism 71 and an X-axis moving mechanism 72. The Z-axis moving mechanism 71 supports the table 30 and moves the table 30 in the top-bottom directions Z. The top-bottom directions Z are orthogonal to the table 30. The Z-axis moving mechanism 71 includes an unillustrated ball screw mechanism and a motor. The ball screw mechanism is driven by the motor. The Z-axis moving mechanism 71 is supported by the X-axis moving mechanism 72 from below. The X-axis moving mechanism 72 moves the table 30 in the sub-scanning directions X. The sub-scanning directions X are parallel to the table 30 and orthogonal to the main scanning directions Y. The X-axis moving mechanism 72 includes an unillustrated ball screw mechanism and a motor.

The conveyor 50 is not limited to a specific configuration. The conveyor 50 only needs to include a moving mechanism that moves at least one of the ink heads 40A through 40D or the table 30 in the main scanning directions Y, a moving mechanism that moves at least one of the ink heads 40A through 40D or the table 30 in the sub-scanning directions X, and a moving mechanism that moves at least one of the ink heads 40A through 40D or the table 30 in the top-bottom directions Z, and is not limited in other respects. For example, the conveyor may move one of the table 30 or the carriage 20 in the main scanning directions Y, the sub-scanning directions X, and the top-bottom directions Z. Alternatively, both the table 30 and the carriage 20 may be moved in the main scanning directions Y, the sub-scanning directions X, and the top-bottom directions Z. Movement of the ink heads 40A through 40D and movement of the table 30 are relative to each other, and components of the ink heads 40A through 40D and the table 30 to be moved and directions of the movement are not specifically limited. The conveyor 50 is electrically connected to the controller 90 and controlled by the controller 90.

As illustrated in FIG. 1, a home position HP is set at the right end of a movable range of the carriage 20. The home position HP is a position at which the carriage 20 is located at, for example, standby for printing. The capping device 80 is disposed below the carriage 20 at the home position HP. The capping device 80 includes the caps 81, a cap moving mechanism 82, and a suction pump 83.

The number of the caps 81 is the same as the number of ink heads 40A through 40D. One cap 81 corresponds to one ink head. Each cap 81 has a vessel shape that is open at the top. The caps 81 are made of, for example, rubber. The upper edges of the caps 81 correspond to the region A3 that contacts the caps 81 and illustrated in FIG. 2. When being attached to the ink heads 40A through 40D, the upper edges of the caps 81 contact the region A3 outside the nozzle region A2.

The plurality of caps 81 are supported by one cap moving mechanism 82. The cap moving mechanism 82 brings the plurality of caps 81 into contact with or away from the nozzle surfaces 42 of the ink heads 40A through 40D. The cap moving mechanism 82 supports the caps 81 from below and moves the caps 81 in the top-bottom directions Z. Accordingly, the caps 81 are attached to or separated from the ink heads 40A through 40D. When the caps 81 are attached to the ink heads 40A through 40D, the upper edges of the caps 81 are pushed against the nozzle surfaces 42. Thus, the caps 81 are in close contact with the nozzle surfaces 42 by elasticity of the caps 81.

The suction pump 83 is connected to the plurality of caps 81 through unillustrated tubes or the like. The suction pump 83 sucks inks and other substances accumulated in the caps 81. The suction pump 83 is electrically connected to the controller 90 and controlled by the controller 90.

As illustrated in FIG. 1, a right end portion of the printer 10 houses the controller 90 that controls various operations of the printer 10. As illustrated in FIG. 1, the controller 90 includes a cleaning controller 91. The cleaning controller 91 controls the conveyor 50 to bring cleaners 120A through 120H of the cleaner assembly 100 into contact with the ink heads 40A through 40D. With a predetermined operation, the ink heads 40A through 40D and the cleaner assembly 100 are moved so that the ink heads 40A through 40D are cleaned. The controller 90 includes controllers for other functions such as printing, which are not described here. The cleaning controller 91 preferably includes a first controller 91a, a second controller 91b, a third controller 91c, a fourth controller 91d, and a fifth controller 91e, for example.

The controller 90 is not limited to a specific configuration. The controller 90 is, for example, a microcomputer. The hardware configuration of the microcomputer is not limited to a specific configuration, and includes, for example, an interface (I/F) that receives printing data and other data from external equipment such as a host computer, a central processing unit (CPU) that executes a command of a control program, a read only memory (ROM) that stores a program to be executed by the CPU, a random access memory (RAM) that is used as a working area where a program is developed, and a memory device such as a memory to store the program and various types of data.

The first controller 91a of the cleaning controller 91 performs a first step of bringing the cleaners 120A through 120H into contact with a portion of the nozzle surface 42 ahead of the first end 42a in the second sub-scanning direction X2 in a cleaning operation. The second controller 91b performs, after the first step, a second step of moving the cleaners 120A through 120H in the second sub-scanning direction X2 relative to the ink heads 40A through 40D while keeping the cleaners 120A through 120H in contact with the nozzle surface 42. The third controller 91c performs, after the second step, a third step of moving the cleaners 120A through 120H away from the nozzle surface 42. The fourth controller 91d performs, after the third step, a fourth step of bringing the cleaners 120A through 120H into contact with a portion of the nozzle surface 42 ahead of the second end 42b in the first sub-scanning direction X1. The fifth controller performs, after the fourth step, a fifth step of moving the cleaners 120A through 120H in the first sub-scanning direction X1 relative to the ink heads 40A through 40D while keeping the cleaners 120A through 120H in contact with the nozzle surface 42. The cleaning operation will be described in detail later.

FIGS. 4A and 4B are perspective views of the cleaner assembly 100. FIG. 4A is a view illustrating all the components of the cleaner assembly 100. FIG. 4B illustrates a state where an absorption member 122, a sheet holding member 130, and the fourth leg 144 are removed from the state illustrated in FIG. 4A. It should be noted that in FIGS. 4A and 4B, the absorption member 122 is indicated by chain double-dashed lines. As illustrated in FIGS. 4A and 4B, the cleaner assembly 100 includes a base 110, the plurality of cleaners 120A through 120H, the sheet holding member 130, a leg section 140.

The base 110 has a plate shape. The base 110 has an upper surface 111 provided with the cleaners 120A through 120H. The base 110 includes a lower surface 112 provided with the leg section 140. The sheet holding member 130 is detachably attached to the base 110. The base 110 is made of, for example, a metal. As illustrated in FIG. 4B, the base 110 includes a contact member holder 113, leg mounters 114, and an attachment groove 115 of the sheet holding member 130.

The contact member holder 113 is provided on the upper surface 111 of the base 110. The contact member holder 113 holds the contact member 121 of the cleaners 120A through 120H. The contact member holder 113 includes a recess 113a. The recess 113a is depressed from the upper surface 111 of the base 110. The recess 113a extends in the main scanning directions Y. A holding base 113b is placed on the recess 113a. The holding base 113b also extends in the main scanning directions Y. The holding base 113b is made of, for example, a sheet metal. The holding base 113b includes a plurality of partitions 113b1. The partitions 113b1 divide the bottom surface of the holding base 113b into eight in the main scanning directions Y. The divided regions constitute eight frames 113b2. The holding base 113b is fixed to the base 110 with bolts 113c.

The legs 141 through 144 of the leg section 140 are detachably attached to the leg mounters 114. The plurality of leg mounters 114 are provided. The leg mounters 114 here are through holes that penetrate the base 110 in the top-bottom directions Z. Among the leg mounters, the first mounter 114a is disposed near the left front end of the base 110. The second mounter 114b is disposed near the right front end of the base 110. The third mounter 114c is disposed near the left rear end of the base 110. The plurality of fourth mounters 114d are disposed near the right rear end of the base 110. Accordingly, a user can select one of the plurality of fourth mounters 114d to which the fourth leg 144 is mounted. A relationship between the fourth mounters 114d and the fourth leg 144 will be described later.

One attachment groove 115 of the sheet holding member 130 faces each of the left and right ends of the recess 113a of the contact member holder 113. The length of the attachment groove 115 in the sub-scanning directions X is longer than the length of the recess 113a in the sub-scanning directions X. The length of the attachment groove 115 in the main scanning directions Y is smaller than length of the recess 113a in the main scanning directions Y. The length of the attachment groove 115 in the sub-scanning directions X is longer than the length of the attachment groove 115 in the main scanning directions Y.

The cleaner assembly 100 includes the plurality of cleaners 120A through 120H. The plurality of cleaners 120A through 120H are disposed on the upper surface 111 of the base 110. The plurality of cleaners 120A through 120H are arranged along the main scanning directions Y. The cleaners 120A through 120H clean the ink heads 40A through 40D of the printer 10. The cleaners 120A through 120H face the ink heads 40A through 40D when the cleaner assembly 100 is attached to the table 30. Each of the cleaners 120A through 120H includes the contact member 121 and the absorption member 122. As will be described later, in this preferred embodiment, the absorption member 122 is shared by all the cleaners 120A through 120H.

The contact member 121 is made of a flexible material. The contact member 121 is made of, for example, rubber, and is preferably made of silicone rubber having a hardness of about 5 or more and about 20 or less, for example. The contact member 121 is formed by bending a flat plate. The flat plate for the contact member 121 is bent by the contact member holder 113 to protrude outward and kept in this state. More specifically, the material for the contact member 121 is inserted in the frames 113b2 divided by the partitions 113b1 of the holding base 113b. In this state, the material for the contact member 121 is bent substantially at the center in the main scanning directions Y, and both ends of the material are inserted in the frames 113b2. The material for the contact member 121 is inserted in the frames 113b2 such that both ends thereof are arranged side by side in the main scanning directions Y. The contact member 121 includes a projecting surface 121a whose center in the main scanning directions Y projects to the side opposite to the base 110. The projecting surface 121a is curved. The projecting surface 121a of the contact member 121 extends in the sub-scanning directions X. The projecting surface 121a has the same cross-sectional shape along the sub-scanning directions X. The contact member 121 has a saddle shape.

Since the contact member 121 has the saddle shape, the contact member 121 has space under the projecting surface 121a. Accordingly, the contact member 121 can be deformed to a degree obtained by the deformation of the space in addition to a degree obtained by flexibility of the contact member 121 itself. The contact member 121 is fixed by a restraint member 113d of the contact member holder 113. The restraint member 113d restrains the contact member 121 to fix both ends of the contact member 121 to each other.

The absorption member 122 is made of a sheet material that absorbs ink. Here, the absorption member 122 is made of a nonwoven fabric, for example. One sheet of the absorption member 122 is used for the plurality of contact members 121. The absorption member 122 is overlaid on the plurality of contact members 121 arranged in the main scanning directions Y. The absorption member 122 is detachably attached to the contact member 121. The length of the absorption member 122 in the main scanning directions Y is larger than the total length of the plurality of contact members 121 arranged in the main scanning directions Y. The length of the absorption member 122 in the sub-scanning directions X is larger than that of the contact member 121 in the sub-scanning directions X. Thus, the absorption member 122 can be placed to cover the top of the plurality of contact members 121.

The absorption member 122 is held by the sheet holding member 130. The sheet holding member 130 has a box shape that is open to the base 110 (at the lower surface). The sheet holding member 130 extends in the main scanning directions Y. The sheet holding member 130 also has an opening 131 at the upper surface. The opening 131 allows the plurality of contact members 121 arranged in the main scanning directions Y to pass threrethrough. Accordingly, when the sheet holding member 130 is attached to the base 110, the projecting surface 121a of the contact member 121 projects upward from the opening 131. The sheet holding member 130 includes hooks 132 at the lower ends of both side surfaces in the main scanning directions Y. The sheet holding member 130 is attached to the base 110 by fitting the hooks 132 to the attachment groove 115 of the base 110.

The side surfaces of the sheet holding member 130 in the sub-scanning directions X are sheet holders 133. The sheet holders 133 project downward from the upper surface of the sheet holding member 130 and extend in the main scanning directions Y. The sheet holders 133 hold the absorption member 122 at the side toward the first sub-scanning direction X1 and the side toward the second sub-scanning direction X2. The sheet holding member 130 holds the absorption member 122 by pressing the absorption member 122 against the contact member 121. Consequently, the absorption member 122 is disposed along the outer periphery of the projecting surface 121a of the contact member 121, and is curved along the projecting surface 121a. The sheet holding member 130 detachably holds the absorption member 122.

On the other hand, in the main scanning directions Y, the sheet holding member 130 does not hold the absorption member 122 such that the absorption member 122 is exposed. The sheet holding member 130 does not include a portion that projects downward, such as the sheet holders 133, at both side surfaces in the main scanning directions Y. The side surfaces of the sheet holding member 130 in the main scanning directions Y constitute exposure portions 134 where the absorption member 122 is exposed. Accordingly, when the sheet holding member 130 is attached, the absorption member 122 is allowed to move in the main scanning directions Y. Thus, the absorption member 122 extends along the outer periphery of the contact member 121.

In this preferred embodiment, each of the cleaners 120A through 120H includes the contact member 121 and the absorption member 122. However, the present disclosure is not limited to this example. It is sufficient that each of the cleaners 120A through 120H includes a projecting surface S1 and the projecting surface S1 is made of a material that is flexible and absorbs ink. For example, each of the cleaners 120A through 120H may be made of a single material. In this case, the material for each of the cleaners 120A through 120H preferably has flexibility and ink absorbency. Specifically, each of the cleaners 120A through 120H may be made of, for example, a sponge having appropriate elasticity. The length of each of the cleaners 120A through 120H in the sub-scanning directions X is smaller than the length of the nozzle surface 42 of each of the ink heads 40A through 40D in the sub-scanning directions X. Here, the length of each of the cleaners 120A through 120H in the sub-scanning directions X is slightly larger than a half of the length of the nozzle surface 42 in the sub-scanning directions X.

A small amount of a cleaning solution is preferably applied to the absorption member 122 in cleaning the ink heads 40A through 40D. The cleaning solution is preferably a liquid in which ink can be dissolved, such as a solvent for ink.

The leg section 140 is disposed on the lower surface 112 of the base 110. The leg section 140 is placed on the table 30 of the printer 10. In the cleaner assembly 100, the leg section 140 is an attachment portion that is detachably attached to the table 30. Here, the leg section 140 includes the plurality of legs 141 through 144. The first leg 141 through the third leg 143 have the same structure. The first leg 141 includes a nut 141a and a front end 141b. As illustrated in FIGS. 4A and 4B, the nut 141a has a hexagonal columnar outer shape extending in the top-bottom directions Z. The nut 141a expands outward of the corresponding leg mounter 114 of the base 110 in plan view. The nut 141a has a screw hole extending in the top-bottom directions Z. The nut 141a is fixed to the base 110 by fastening a bolt 141c to the screw hole. The leg section 140 is disposed inside the contour of the base 110 in plan view. Accordingly, the cleaner assembly 100 can be made compact without extension of the leg section 140 outside the base 110.

The front end 141b is provided at the lower end of the nut 141a. The front end 141b has a cylindrical shape whose outer diameter is smaller than that of the nut 141a. A step is present at the boundary between the nut 141a and the front end 141b. The outer diameter of the front end 141b corresponds to the inner diameter of each of the placement holes 31a through 31c of the table 30. The first leg 141 is inserted in the first placement hole 31a of the table 30. The first leg 141 is positioned in the main scanning directions Y and the sub-scanning directions X by inserting the front end 141b in the first placement hole 31a. The nut 141a buts against the table 30 to be positioned in the top-bottom directions Z. The same holds for the second leg 142 and the third leg 143. The second leg 142 is inserted in the second placement hole 31b of the table 30. The third leg 143 is inserted in the third placement hole 31c of the table 30. The leg section 140 defines and functions as a second positioning mechanism corresponding to the first positioning mechanism (the placement holes 31a through 31c in this preferred embodiment) disposed on the table 30.

The fourth leg 144 is detachable from the fourth mounters 114d of the base 110. As described above, the plurality of fourth mounters 114d are provided. The number of fourth mounters 114d to which the fourth legs 144 can be attached is larger than the number of fourth legs 144. Thus, the locations of the fourth legs 144 on the base 110 are movable by switching the fourth mounters 114d to which the fourth legs 144 are attached. Here, the number of fourth legs 144 is one, and the number of the fourth mounters 114d is three. The number of legs whose position is movable on the base 110 is not limited to one, and may be two or more. The number of leg mounters to which movable legs can be attached only needs to be larger than the number of legs, and is not specifically limited to other respects.

As illustrated in FIG. 2, a movable range of the fourth leg 144 is set within the print area A1 of the table 30. That is, in plan view, all the fourth mounters 114d are located within the print area A1. It should be noted that the movable range of the fourth leg 144 only needs to partially overlap the print area A1 of the table 30, and the entire movable range does not need to be included in the print area A1. In other words, the fourth leg 144 may move to the outside of the print area A1. The fourth leg 144 also includes a nut and is fixed to the base 110 with a bolt. The fourth leg 144 is not necessarily disposed on an area where a hole is formed on the table 30, and thus, has a shape having no front end.

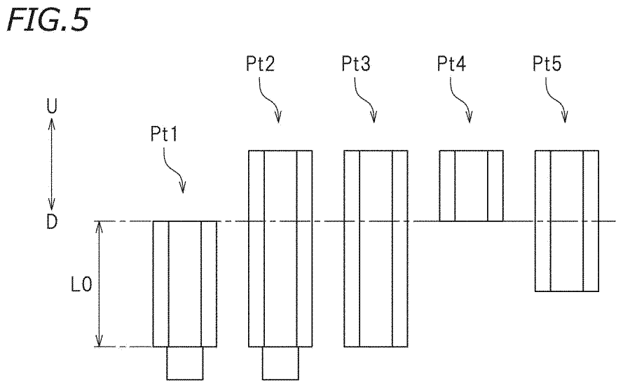

The length of the leg section 140 is changeable. In this preferred embodiment, each of the plurality of legs 141 through 144 has a changeable length. Each of the first leg 141 through the fourth leg 144 includes one of a plurality of leg portions attachable to the base 110 and having different lengths. FIG. 5 schematically illustrates an example of leg portions. As illustrated in FIG. 5, the leg portions include, for example, five types of leg portions from a first leg portion Pt1 through a fifth leg portion Pt5. The leg portions Pt1 through Pt5 include leg portions having different nut lengths. Some of the leg portions Pt1 through Pt5 include front ends, and the other do not include front ends. A method for selecting the leg portions will be described later.

The following description will be directed to attachment of the cleaner assembly 100 to the printer 10 and cleaning operations of the ink heads 40A through 40D. First, attachment of the cleaner assembly 100 to the printer 10 will be described.

The cleaner assembly 100 according to this preferred embodiment is attachable to the table 30 without removal of the jig 200. The cleaner assembly 100 lifts the base 110 to a position above the jig 200 with the leg section 140. The user selects a leg portion having a length appropriate for the lifting. A length L0 illustrated in FIG. 5 is a thickness of the jig 200. To avoid the jig 200, the leg section 140 needs to lift the base 110 such that the lower surface 112 of the base 110 is located higher than the thickness L0 of the jig. Thus, the leg portion Pt2 is selected for the first leg 141 through the third leg 143. The nut length of the leg portion Pt2 is larger than the thickness L0 of the jig. On the other hand, the length of the leg portion Pt1 for the first leg 141 through the third leg 143 is equal to the thickness L0 of the jig. The first leg 141 through the third leg 143 are legs standing outside the print area A1 of the table 30. In view of this, the length of the first leg 141 through the third leg 143 needs to be larger than the thickness L0 of the jig 200.

As illustrated in FIG. 2, the fourth leg 144 stands inside the print area A1. The user can select the fourth mounter 114d to which the fourth leg 144 is attached. In this manner, the user selects a location at which the fourth leg 144 stands on the table 30. In the example illustrated in FIG. 2, one fourth mounter 114d1 of the plurality of fourth mounters 114d is located on one of the housings 210 of the jig 200. The housings 210 are through holes formed in the jig 200. Thus, the user can select the mounter 114d1 as a leg mounter to which the fourth leg 144 is attached. By selecting the mounter 114d1, the fourth leg 144 is allowed to stand on the table 30. Accordingly, the cleaner assembly 100 is able to be placed with stability. In this case, the user selects the leg portion Pt3 as the fourth leg 144. The leg portion Pt3 has the same nut length as that of the leg portion Pt2, and does not have a front end.

In a case where the fourth leg 144 cannot pass through the housing 210 of the jig 200, the user can place the fourth leg 144 on the jig 200. In this case, the user selects the leg portion Pt4 as the fourth leg 144. The leg portion Pt4 has a nut length equal to a difference between the height of the leg portion Pt2 and the thickness L0 of the jig 200, and does not have a front end.

Although FIG. 5 illustrates only the five types of leg portions Pt1 through Pt5, leg portions having various lengths may be prepared as necessary. Leg portions may be prepared on the assumption that the jig 200 is produced from a material having a standardized thickness. In the case of assuming that the jig 200 is produced from a material having a standardized thickness, lengths of leg portions to be prepared are limited to specific combinations. Thus, with this method, the number of types of leg portions is able to be reduced. It should be noted that preparation of leg portions may not depend on a particular thickness of the jig 200, and the thickness of the jig 200 may be prepared in units of 1 mm, for example. In the absence of the jig 200, the leg section 140, of course, defines and functions as a positioning mechanism of the cleaner assembly 100.

After the leg portion has been selected and the legs 141 through 144 have been attached to the base 110, the cleaner assembly 100 is attached to the unit placing area 30a. This attachment is performed by inserting the first leg 141 through the third leg 143 in the first placement hole 31a through the third placement hole 31c of the table 30, respectively. This method enables positioning between the printer 10 and the cleaner assembly 100 to be performed easily. The fourth leg 144 here is irrelevant to the positioning of the cleaner assembly 100, and functions to place the cleaner assembly 100 with stability.

Once the cleaner assembly 100 is attached to the table 30, the cleaners 120A through 120H face the ink heads 40A through 40D. Specifically, the cleaners 120A through 120H are placed such that the projecting surfaces S1 face the ink heads 40A through 40D. In each of the cleaners 120A through 120H, the contact member 121 is located closer to the table 30 than the absorption member 122, and the absorption member 122 is located closer to the ink heads 40A through 40D than the contact member 121.

Next, cleaning operations of the ink heads 40A through 40D will be described. In this preferred embodiment, the conveyor 50 moves the ink heads 40A through 40D and the table 30 relative to each other with the cleaner assembly 100 attached to the table 30. Accordingly, the ink heads 40A through 40D and the cleaner assembly 100 move relative to each other. Operation of the conveyor 50 is controlled by the cleaning controller 91. With this movement, cleaning of the ink heads 40A through 40D is performed.

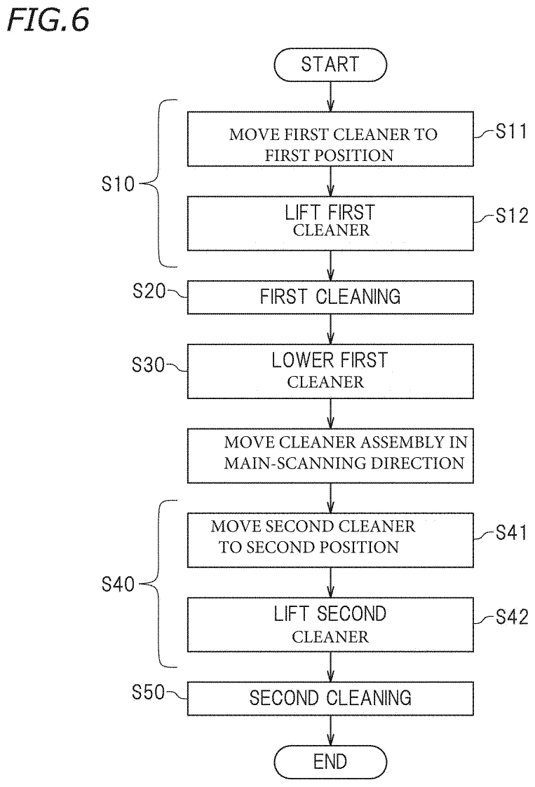

FIG. 6 is a flowchart depicting a cleaning operation of the first ink head 40A. As depicted in FIG. 6, the cleaning operation of the first ink head 40A includes five steps S10 through S50. More specifically, first step S10 includes step S11 and step S12. Fourth step S40 includes step S41 and step S42. In this preferred embodiment, after third step S30, a sliding operation of moving the cleaner assembly 100 in the main scanning directions Y relative to the ink heads 40A through 40D is performed before fourth step S40. Although specifically described later, this sliding operation may not be performed in some preferred embodiments.

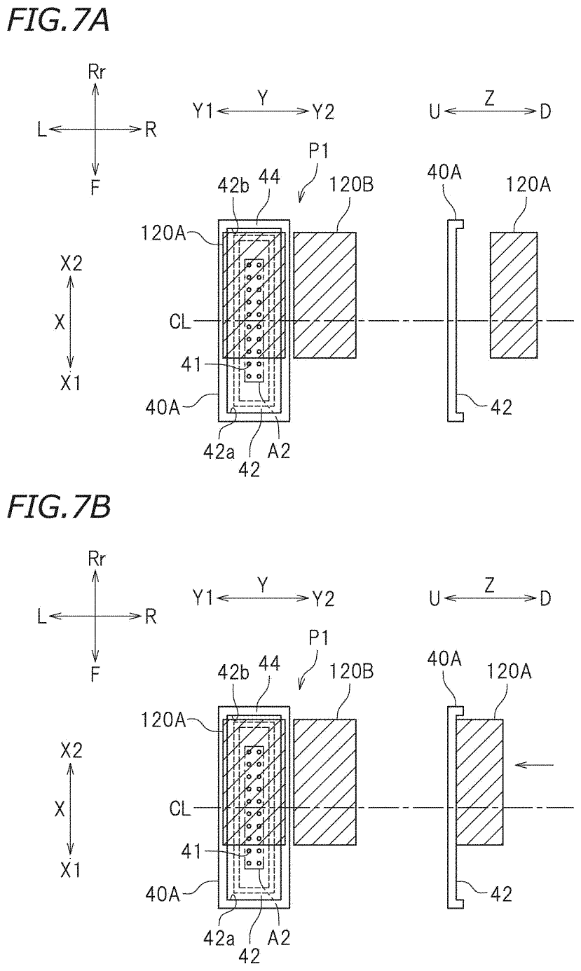

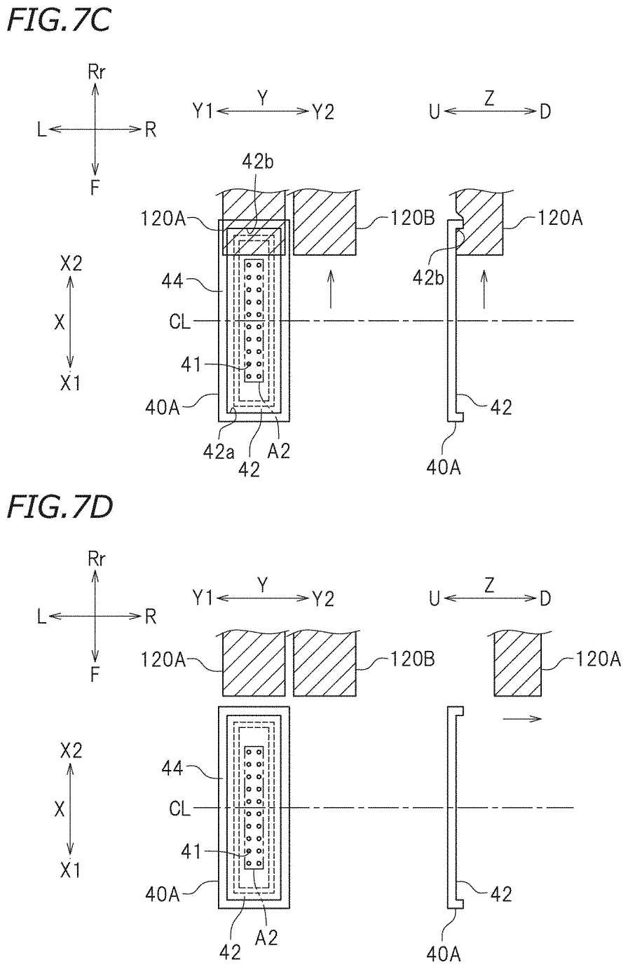

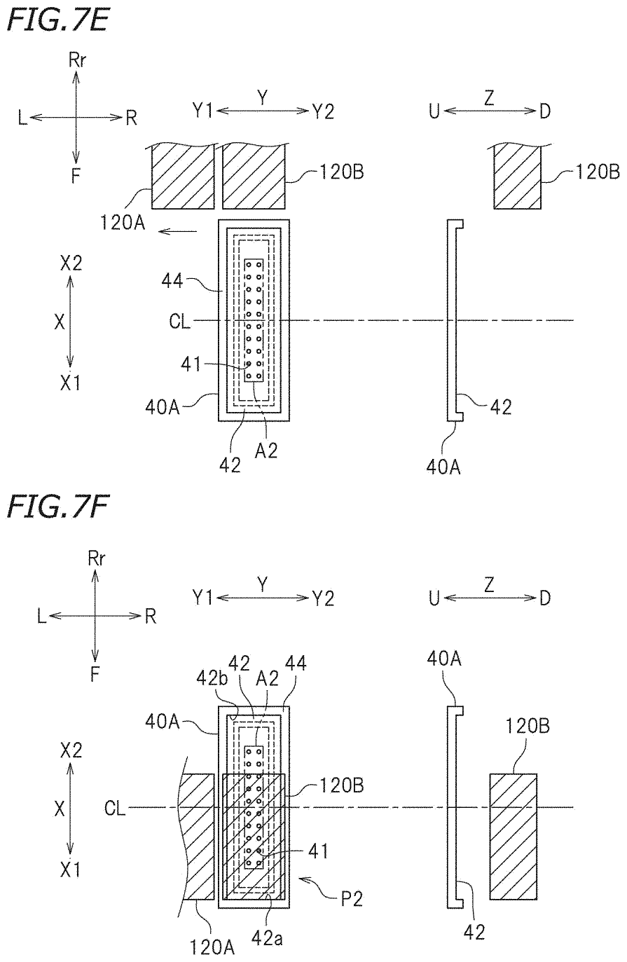

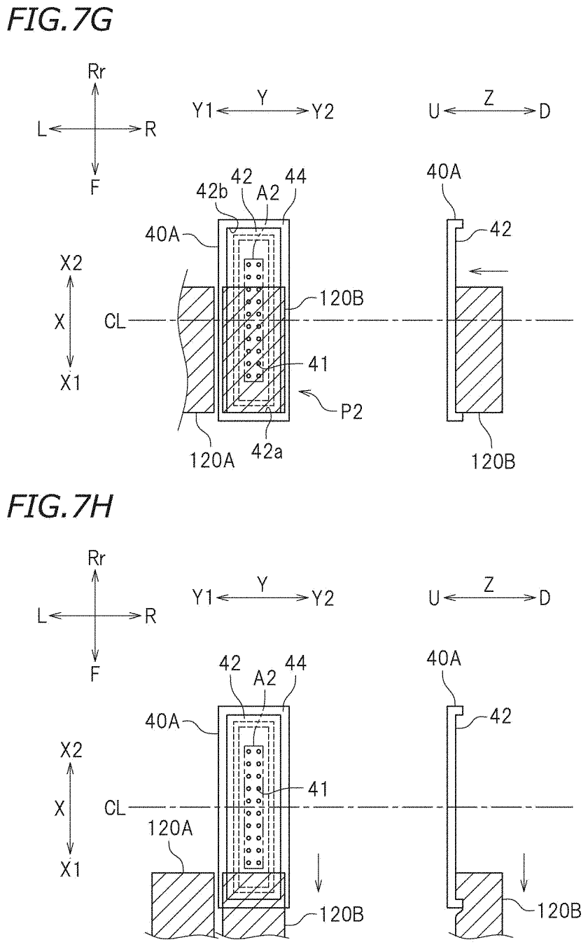

FIGS. 7A through 7H schematically illustrate positional relationships among the first ink head 40A, the first cleaner 120A, and the second cleaner 120B in the cleaning operation. FIG. 7A illustrates a positional relationship among the first ink head 40A, the first cleaner 120A, and the second cleaner 120B in step S11. FIG. 7B illustrates a positional relationship among the first ink head 40A, the first cleaner 120A, and the second cleaner 120B in step S12. FIG. 7C illustrates a positional relationship among the first ink head 40A, the first cleaner 120A, and the second cleaner 120B in step S20. FIG. 7D illustrates a positional relationship among the first ink head 40A, the first cleaner 120A, and the second cleaner 120B in step S30. FIG. 7E illustrates a positional relationship among the first ink head 40A, the first cleaner 120A, and the second cleaner 120B in the sliding operation. FIG. 7F illustrates a positional relationship among the first ink head 40A, the first cleaner 120A, and the second cleaner 120B in step S41. FIG. 7G illustrates a positional relationship among the first ink head 40A, the first cleaner 120A, and the second cleaner 120B in step S42. FIG. 7H illustrates a positional relationship among the first ink head 40A, the first cleaner 120A, and the second cleaner 120B in step S50. In each of FIGS. 7A through 7H, a schematic plan view is illustrated at the left. A schematic side view is illustrated at the right.

As depicted in FIG. 6, in step S11, the first cleaner 120A is moved to a first position P1 under the first ink head 40A. The movement of the cleaner assembly 100 is performed through movement of the first ink head 40A by the carriage conveyor 60 and movement of the table 30 by the table conveyor 70. The cleaner assembly 100 is positioned relative to the table 30 by using the leg section 140 and the placement holes 31a through 31c. Thus, the cleaning controller 91 is configured or programmed to place the cleaner assembly 100 and the table 30 at desired relative positions.

As illustrated in the plan view of FIG. 7A, at the first position P1, the first cleaner 120A is disposed ahead of the first end 42a of the nozzle surface 42 in the second sub-scanning direction X2. More specifically, the first cleaner 120A is disposed such that the front end is located ahead of a center line CL of the nozzle region A2 in the sub-scanning directions X, in the first sub-scanning direction X1. At this time, as illustrated in the side view of FIG. 7A, the first cleaner 120A is separated from the first ink head 40A under the first ink head 40A.

In step S12, the cleaner assembly 100 is moved upward. Accordingly, the first cleaner 120A is brought into contact with the nozzle surface 42 of the first ink head 40A. More specifically, the first cleaner 120A contacts a portion of the nozzle surface 42 ahead of the first end 42a in the second sub-scanning direction X2. In this preferred embodiment, the rear end of the first cleaner 120A also contacts the nozzle surface 42. The first cleaner 120A contacts a portion of the nozzle surface 42 between the first end 42a and the second end 42b.

In subsequent second step S20, a first cleaning is performed. As illustrated in FIG. 7C, in second step S20, the cleaning controller 91 moves the first cleaner 120A in the second sub-scanning direction X2 while keeping the first cleaner 120A in contact with the nozzle surface 42 of the first ink head 40A. Accordingly, more than a half of the nozzle surface 42 of the first ink head 40A toward the second sub-scanning direction X2 is cleaned.

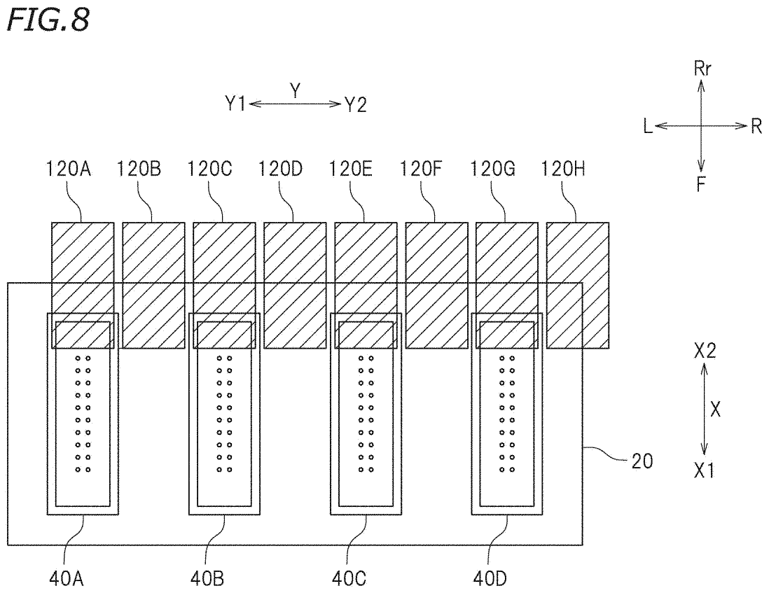

FIG. 8 is a plan view schematically illustrating a positional relationship between the ink heads 40A through 40D and the cleaners 120A through 120H at the time of second step S20. As illustrated in FIG. 8, in second step S20, the second ink head 40B is aligned with the third cleaner 120C in the main scanning directions Y. Thus, in second step S20, the second ink head 40B is cleaned by the third cleaner 120C. Similarly, the third ink head 40C is cleaned by the fifth cleaner 120E. The fourth ink head 40D is cleaned by the seventh cleaner 120G. The pitch of the cleaners 120A through 120H in the main scanning directions Y is a half of the pitch of the ink heads 40A through 40D in the main scanning directions Y. Thus, the plurality of ink heads 40A through 40D are cleaned by the plurality of cleaners 120A, 120C, 120E, and 120G arranged in the main scanning directions Y at the same time. The plurality of cleaners 120A, 120C, 120E, and 120G are arranged in the main scanning directions Y at each second cleaner.

In the cleaning of the first ink head 40A, the configuration of the first cleaner 120A achieves advantages. The first cleaner 120A includes the projecting surface S1 projecting toward the first ink head 40A. The projecting surface S1 has flexibility and ink absorbency. The flexible projecting surface S1 projects toward the first ink head 40A so that adhesion to the nozzle 41 is enhanced as compared to a case where the cleaner includes a flat upper end, for example. In particular, the first ink head 40A includes the head guard 44. Thus, if the cleaner had a flat upper end, the head guard 44 would be an obstacle and prevent close adhesion between the cleaner and the nozzles 41. The projecting surface S1 is advantageous especially in such a case that the ink head includes a portion projecting from the nozzle region of, for example, the head guard. The first cleaner 120A has ink absorbency, and cleans the nozzles 41 by absorbing ink.

In this preferred embodiment, the first cleaner 120A extends in the sub-scanning directions X while maintaining a uniform cross section projecting upward. With this configuration, ink of the nozzles 41 is able to be absorbed at the same time in a large area in the sub-scanning directions X.

In this preferred embodiment, the first cleaner 120A includes the contact member 121 and the absorption member 122. The contact member 121 contributes to flexibility among the functions of the first cleaner 120A. The absorption member 122 contributes to ink absorbency among the functions of the first cleaner 120A. With this configuration, it is sufficient to exchange only the absorption member 122 that has absorbed ink with another after cleaning, and thus, consumables are able to be saved.

In addition, the contact member 121 preferably is formed by bending a flat plate material. Accordingly, space is provided under the projecting surface 121a. With this configuration, the contact member 121 is able to be greatly deformed in the top-bottom directions Z. In view of this, a force of the first cleaner 120A in pressing the first ink head 40A at contact can be made uniform or substantially uniform independently of variations of the distance between the first ink head 40A and the first cleaner 120A.

In this preferred embodiment, at the start of step S20, the rear end of the first cleaner 120A is disposed ahead of the second end 42b in the first sub-scanning direction X1 so that the second end 42b is cleaned effectively. A step is provided in the second end 42b that is a portion of the boundary between the head guard 44 and the nozzle surface 42. Ink is likely to be accumulated at this step and it is difficult to remove the accumulated ink by cleaning. In the cleaning system 1 according to this preferred embodiment, however, the rear end of the first cleaner 120A passes over the second end 42b in second step S20. At this time, corners of the rear end of the first cleaner 120A enter the step so that ink on the second end 42b is able to be effectively removed.

This advantage can be similarly obtained between the second ink head 40B and the third cleaner 120C, between the third ink head 40C and the fifth cleaner 120E, and between the fourth ink head 40D and the seventh cleaner 120G.

In the subsequent third step S30, as illustrated in FIG. 7D, the cleaning controller 91 lowers the cleaner assembly 100. Accordingly, the cleaning controller 91 moves the first cleaner 120A away from the nozzle surface 42. The third controller 91c moves the cleaner assembly 100 in, for example, the top-bottom directions Z to move the cleaner assembly 100 away from the nozzle surface 42. The movement direction in this case only needs not to be in parallel with the nozzle surface 42, and does not need to coincide with the top-bottom directions Z.

As illustrated in FIG. 7E, in the sliding operation, the cleaning controller 91 moves the cleaner assembly 100 in the first main scanning direction Y1 relative to the first ink head 40A. This movement is actually performed by movement of the carriage 20 in the second main scanning direction Y2. The distance of movement of the first ink head 40A at this time is equal to the pitch of the cleaners 120A through 120H in the main scanning directions Y, as illustrated in FIG. 7E. In view of this, the first ink head 40A is moved to the same position as the second cleaner 120B in the sub-scanning directions X. At this time, the second ink head 40B is moved to the same position as the fourth cleaner 120D in the sub-scanning directions X. The third ink head 40C is moved to the same position as the sixth cleaner 120F in the sub-scanning directions X. The fourth ink head 40D is moved to the eighth cleaner 120H in the sub-scanning directions X.

In step S41, as illustrated in the plan view of FIG. 7F, the second cleaner 120B is moved to a second position P2 under the first ink head 40A. As illustrated in FIG. 7F, at the second position P2, the second cleaner 120B is disposed ahead of the second end 42b of the nozzle surface 42 in the first sub-scanning direction X1. More specifically, the second cleaner 120B is disposed such that the rear end is located ahead of the center line CL of the nozzle region A2 in the sub-scanning directions X, in the second sub-scanning direction X2. At this time, as illustrated in the side view of FIG. 7F, the second cleaner 120B is separated from the first ink head 40A under the first ink head 40A.

In step S42, as illustrated in FIG. 7G, the cleaner assembly 100 is moved upward. Accordingly, the second cleaner 120B is brought into contact with the nozzle surface 42 of the first ink head 40A. More specifically, the second cleaner 120B contacts a portion of the nozzle surface 42 ahead of the second end 42b in the first sub-scanning direction X1. In this preferred embodiment, the front end of the second cleaner 120B also contacts the nozzle surface 42. The second cleaner 120B contacts a portion of the nozzle surface 42 between the first end 42a and the second end 42b.

In the subsequent fifth step S50, second cleaning is performed. As illustrated in FIG. 7H, in the fifth step S50, the cleaning controller 91 moves the second cleaner 120B in the first sub-scanning direction X1 while keeping the second cleaner 120B in contact with the nozzle surface 42 of the first ink head 40A. Accordingly, more than a front half of the nozzle surface 42 of the first ink head 40A in the first sub-scanning direction X1 is cleaned. To avoid residues of wiping, a region where cleaning is performed in second step S20 and a region where cleaning is performed in fifth step S50 partially overlap each other. Similarly, the second ink head 40B, the third ink head 40C, and the fourth ink head 40D are cleaned by the fourth cleaner 120D, the sixth cleaner 120F, and the eighth cleaner 120H, respectively.

In this manner, cleaning of one ink head is divided into two portions in this preferred embodiment. Specifically, in the first cleaning, the first cleaner 120A is disposed such that at least one end of the first cleaner 120A overlaps the nozzle region A2 of the first ink head 40A, and then, the first cleaner 120A is moved toward the outside of the nozzle region A2. In fifth step S50, the first cleaning is performed with the first cleaner 120A moved in the opposite direction.

Typical cleaning of ink heads has been performed in one way from one end to the other of a nozzle surface. For example, in the case of the first ink head 40A according to this preferred embodiment, with a typical method, a cleaner such as a wiper is retained at a height at which the cleaner is able to contact the nozzle surface 42, outside one end of the first ink head 40A. The cleaner is moved toward the center of the first ink head 40A while being retained at the same height. Consequently, the cleaner first contacts the head guard 44, then contacts the region A3 that contacts the cap 81, and then contacts the nozzle region A2. Here, as described above, ink is likely to be accumulated at an end of the nozzle surface 42 (i.e., boundary between the head guard 44 and the nozzle surface 42 in this preferred embodiment). Ink is often attached to the region A3 in detaching and attaching the caps 81. Thus, the cleaner draws ink that has removed from the end of the nozzle surface 42 or the region A3, to the nozzle region A2. Accordingly, ink removed from the end of the nozzle surface 42 or the region A3 might adhere to the nozzles 41. In particular, in a case where ink removed from the end of the nozzle surface 42 or the region A3 has a solidified portion, the solidified ink might enter the nozzles 41 to cause problems such as a failure in discharging ink. As described above, ink might adhere to the outside of the nozzle region A2, and if such ink is brought into the nozzle region A2, problems such as a failure in discharging ink might occur.

In view of this, in the printer 10 according to this preferred embodiment, first, the cleaners 120A through 120H are brought into contact with the nozzle surfaces 42, and then the cleaner assembly 100 is moved toward the outside of the nozzle surfaces 42. With this operation, ink removed from a region outside the nozzle region A2 is not brought into the nozzle region A2. Thus, the possibility of occurrence of problems caused by such ink in the nozzles 41 is able to be eliminated. In this preferred embodiment, each nozzle surface 42 is entirely cleaned by performing cleaning from the center of the nozzle surface 42 toward the periphery thereof twice in total in different directions.

In this preferred embodiment, the movement in the first step S10 and the third step S30 in the main scanning directions Y and the sub-scanning directions X is performed by lowering the cleaner assembly 100 such that the cleaners 120A through 120H do not contact the ink heads 40A through 40D. With this operation, it is possible to prevent entering of ink from outside the nozzle region A2 into the nozzle region A2 each of before the first cleaning and before the second cleaning.

In addition, in this preferred embodiment, the printer 10 cleans one ink head with two cleaners. For example, the first cleaning of the first ink head 40A is performed by the first cleaner 120A. The second cleaning of the first ink head 40A is performed by the second cleaner 120B. With this operation, the two cleaning operations can be individually performed by different clean cleaners. Thus, cleaning of the ink heads 40A through 40D can be performed with higher quality. In this preferred embodiment, since the nozzle row 43a and the nozzle row 43b are arranged side by side in the main scanning directions Y, the plurality of cleaners 120A through 120H are also arranged side by side in the main scanning directions Y. The cleaning controller 91 performs a sliding operation of the cleaner assembly 100 between third step S30 and fourth step S40.

In the above description, different cleaners are used between the first cleaning and the second cleaning, but the same cleaner may be used. In this case, the cleaner assembly 100 includes the same number (for example, four in this preferred embodiment) of cleaners as the number of ink heads 40A through 40D of the printer 10. In this case, the sliding operation described above does not need to be performed.

The preferred embodiments described above have variations. Some preferred variations will now be described. In the following description of variations, members already described in the above preferred embodiments are denoted by the same reference characters, and description for the same members will not be repeated or will be simplified.

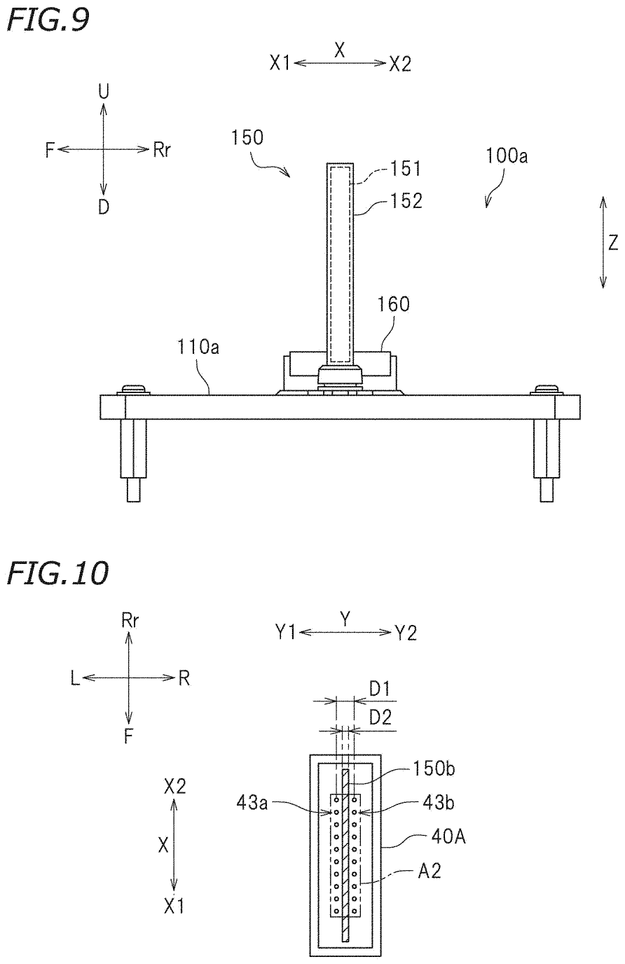

In a first variation, a cleaner assembly 100a having a configuration different from that of the preferred embodiments described above is used. FIG. 9 is a side view schematically illustrating the cleaner assembly 100a according to the first variation. As illustrated in FIG. 9, the cleaner assembly 100a includes a wiper 150 as a cleaner. A base 110a includes a vice 160 that holds the wiper 150.

The wiper 150 has a plate shape. The wiper 150 extends in the main scanning directions Y (direction orthogonal to the drawing sheet of FIG. 9). The wiper 150 is disposed substantially vertically. The wiper 150 here includes a contact member 151 and an absorption member 152. The contact member 151 is disposed to bring the wiper 150 into close contact with the ink heads 40A through 40D. The contact member 151 is made of, for example, a flexible material such as polyurethane foam.

The absorption member 152 has a sheet shape. The absorption member 152 is overlaid on the contact member 151. In cleaning the ink heads 40A through 40D, a small amount of a cleaning solution is applied to the absorption member 122. The contact member 151 and the absorption member 152 are held by the vice 160 as the wiper 150. The configuration of the wiper 150 is not limited to this preferred embodiment. For example, the wiper 150 is configured only to wipe ink, and does not need to absorb ink. In such a case, the wiper 150 may be made of only a flexible material such as polyurethane foam, for example.

In a second variation, cleaning is performed in a direction different from that in the preferred embodiments described above. The cleaners extend in directions different from those in the preferred embodiments.

FIG. 10 is a plan view schematically illustrating a first ink head 40A and a cleaner 150b according to the second variation. In this variation, a cleaner assembly includes the wiper defining the cleaner 150b. The cleaner 150b here extends in the sub-scanning directions X. The first nozzle row 43a and the second nozzle row 43b extend in the sub-scanning directions X. It should be noted that the direction in which cleaning is performed is the first main scanning direction Y1 and the second main scanning direction Y2 in this preferred embodiment. With respect to a direction in which cleaning is performed (cleaning direction), the first nozzle row 43a and the second nozzle row 43b extend in directions orthogonal to the cleaning direction. The first nozzle row 43a and the second nozzle row 43b are arranged in the cleaning direction.

As illustrated in FIG. 10, a width D2 of the cleaner 150b in the main scanning directions Y is smaller than a distance D1 between the first nozzle row 43a and the second nozzle row 43b in the main scanning directions Y. In view of this, as illustrated in FIG. 10, the cleaner 150b is able to be disposed between the first nozzle row 43a and the second nozzle row 43b in plan view.

In cleaning the first ink head 40A, first step S10 through fifth step S50 of the preferred embodiment described above are performed in different cleaning directions. In the first step of this variation, the first controller 91a of the cleaning controller 91 brings the cleaner 150b into contact with a portion of the nozzle surface 42 between the first nozzle row 43a and the second nozzle row 43b. In the second step, the cleaner assembly is moved from this position in the second main scanning direction Y2. Through the second step, the second nozzle row 43b is cleaned.

In the third step, the cleaning controller 91 moves the cleaner 150b away from the nozzle surface 42. In the fourth step, the fourth controller 91d of the cleaning controller 91 brings the cleaner 150b into contact with a portion of the nozzle surface 42 between the first nozzle row 43a and the second nozzle row 43b again. In the fifth step, the cleaner assembly is moved from this position in the first main scanning direction Y1. In the fifth step, the first nozzle row 43a is cleaned.

Similar to the preferred embodiments described above, with the cleaning method, ink and other substances attached to the outside of the nozzle region A2 are not brought into the nozzle region A2 because the cleaner 150b is moved outward from the center of the nozzle region A2. In addition, with this cleaning method, since the direction in which the nozzle rows 43a and 43b extend is orthogonal to the cleaning direction, ink does not move from one of the nozzles 41 to another. As a result, higher-quality cleaning is able to be performed.

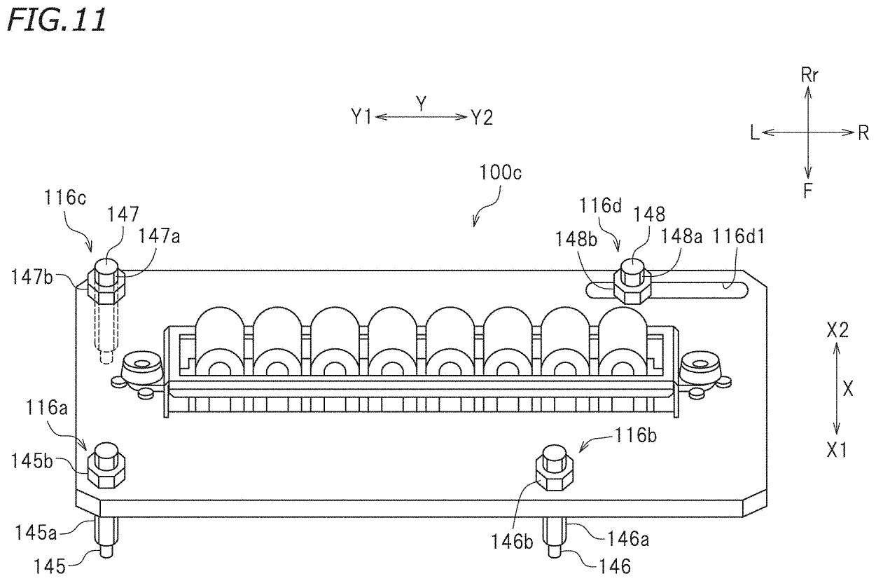

In a third variation, a configuration for changing the length of a leg and a configuration for changing the position of the fourth leg are different from those in the preferred embodiments described above. FIG. 11 is a perspective view of a cleaner assembly 100c according to a third variation. In this variation, as illustrated in FIG. 11, a base 110c includes leg mounters including a first mounter 116a through a fourth mounter 116d.

Each of the first mounter 116a through the third mounter 116c according to this variation includes a screw hole. The screw hole penetrates the base 110c in the top-bottom directions Z. A first leg 145 through a third leg 147 corresponding to the first mounter 116a through the third mounter 116c respectively include bolts 145a through 147a. The bolts 145a through 147a are fitted into the screw holes of the first mounter 116a through the third mounter 116c, respectively. Nuts are fitted onto the bolts 145a through 147a. For example, a nut 145b is fitted onto the bolt 145a of the first leg 145. The nut 145b here is disposed on top of the base 110c. The first leg 145 is rotated while being fitted into the screw hole of the first mounter 116a so that the length of projection of the first leg 145 from the lower surface of the base 110c can be changed. When the projection length is determined, the nut 145b is tightened. Accordingly, the first leg 145 is fixed. The same holds for the second leg 146 and the third leg 147.

The fourth mounter 116d includes a long hole 116d1. The long hole 116d1 is a long hole penetrating the base 110c in the top-bottom directions Z, and extends in the main scanning directions Y here. The planar shape of the long hole 116d1 is not limited to a specific shape. The long hole 116d1 may extend in the sub-scanning directions X or may be bent at an intermediate position and extend in both of the main scanning directions Y and the sub-scanning directions X. Alternatively, a plurality of long holes 116d1 may be disposed. The fourth leg 148 includes a bolt 148a. The bolt 148a is inserted in the long hole 116d1. An upper nut 148b and an unillustrated lower nut are fitted onto the bolt 148a. The upper nut 148b is disposed on top of the base 110c. The lower nut is disposed on the bottom of the base 110c. The fourth leg 148 is moved horizontally along the long hole 116d to thereby change its position on the base 110c. The length of projection of the fourth leg 148 from the lower surface of the base 110c can be changed by changing the positions of the upper nut 148b and the lower nut. When the projection length is determined, the upper nut 148b and the lower nut are fastened together. Accordingly, the fourth leg 148 is fixed.

This configuration also enables adjustment of the length of legs of the cleaner assembly and the position of at least one leg of the cleaner assembly. In particular, this configuration enables detailed adjustment of the length of legs and the position of at least one leg.

The foregoing description is directed to preferred embodiments and variations thereof. The preferred embodiments, however, are merely examples, and techniques disclosed here can be performed in various preferred embodiments. For example, in the preferred embodiments described above, the cleaner assembly is attached to the table on which the print object is placed. The cleaner assembly, however, only needs to be movable between relative positions to the ink head, and is not limited to a unit attached to the table. For example, the cleaner assembly may be mounted on a conveyor except for the table. Alternatively, the ink heads may move in three dimensions, and the cleaner assembly may be fixed. A configuration for changing the positional relationship between the cleaner assemblies and the ink heads is not limited to a specific configuration.

In the preferred embodiments described above, the cleaner assembly includes the plurality of legs. The configuration of the leg section of the cleaner assembly, however, is not limited to these preferred embodiments. For example, the cleaner assembly may include one leg section having an L or C shape in plan view. The leg section of the cleaner assembly does not need to be disposed on the lower surface of the base. The leg section may be attached to, for example, a side surface or an upper surface of the base. In addition, the cleaner assembly does not need to include the leg section to avoid a jig used to position a print object. The method for attaching the cleaner assembly to the table is not limited to a specific method. For example, the cleaner assembly may be attached to the table through another member.

The configuration of the cleaner is not limited to a specific configuration. The configuration of the cleaner described above is a preferred example, and is not intended to limit the shape, the material, and the arrangement, for example, of the cleaners. For example, the projecting surface of each cleaner does not need to include a curved surface. Movement of the ink heads and the cleaner assemblies in cleaning are not limited to those described above.

Other configurations of the ink jet printer and the cleaner assembly are not limited to specific configurations, without otherwise specified. For example, the technique disclosed here is also applicable to a roll-to-roll ink jet printer, for example. The technique is also applicable to a device partially incorporating an ink jet printer, such as a printer with a cutting head, for example.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing preferred embodiments of the principles of the present invention. These preferred embodiments are provided with the understanding that they are not intended to limit the present invention to the preferred embodiments described in the specification and/or shown in the drawings. The present invention encompasses any of preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or referred to during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An ink jet printer comprising:
an ink head including a nozzle surface provided with a plurality of nozzles;
a cleaner assembly including a cleaner to contact the nozzle surface;
a conveyor that moves the ink head and the cleaner assembly relative to each other; and
a controller that controls the conveyor; wherein
the nozzle surface includes:
a first end in a first direction; and
a second end in a second direction opposite to the first direction; and
the controller includes:
a first controller that performs a first step of bringing the cleaner into contact with a portion of the nozzle surface ahead of the first end in the second direction;
a second controller that performs, after the first step, a second step of moving the cleaner relative to the ink head in the second direction while keeping the cleaner in contact with the nozzle surface;
a third controller that performs, after the second step, a third step of moving the cleaner away from the nozzle surface;
a fourth controller that performs, after the third step, a fourth step of bringing the cleaner into contact with a portion of the nozzle surface ahead of the second end in the first direction; and
a fifth controller that performs, after the fourth step, a fifth step of moving the cleaner relative to the ink head in the first direction while keeping the cleaner in contact with the nozzle surface.

2. The ink jet printer according to claim 1, wherein
a length of the cleaner in the first direction is smaller than a length of the nozzle surface in the first direction; and
the first controller and the fourth controller bring the cleaner into contact with a portion of the nozzle surface between the first end and the second end.

3. The ink jet printer according to claim 1, wherein the plurality of nozzles are arranged in the first direction and define a nozzle row extending in the first direction.

4. The ink jet printer according to claim 3, wherein
the cleaner includes a first cleaner and a second cleaner;
the first controller brings the first cleaner into contact with a portion of the nozzle surface ahead of the first end in the second direction;
the second controller moves the first cleaner relative to the ink head in the second direction while keeping the first cleaner in contact with the nozzle surface;
the third controller moves the first cleaner away from the nozzle surface;
the fourth controller brings the second cleaner into contact with a portion of the nozzle surface ahead of the second end in the first direction; and
the fifth controller moves the second cleaner relative to the ink head in the first direction while keeping the second cleaner in contact with the nozzle surface.

5. The ink jet printer according to claim 4, wherein
the first cleaner and the second cleaner are arranged in an orthogonal direction that is orthogonal or substantially orthogonal to the first direction; and
the controller includes a sixth controller that moves the cleaner assembly relative to the ink head in the orthogonal direction, after the third step and before the fourth step.

6. The ink jet printer according to claim 1, wherein
the plurality of nozzles are arranged in a first nozzle row and a second nozzle row each extending in an orthogonal direction that is orthogonal or substantially orthogonal to the first direction;
the first nozzle row and the second nozzle row are arranged side by side in the first direction;
a length of the cleaner in the first direction is smaller than a distance between the first nozzle row and the second nozzle row in the first direction; and
the first controller and the fourth controller bring the cleaner into contact with a portion of the nozzle surface between the first nozzle row and the second nozzle row.

7. The ink jet printer according to claim 1, wherein the third controller moves the cleaner assembly relative to the ink head in a direction not parallel to the nozzle surface to move the cleaner away from the nozzle surface.

8. The ink jet printer according to claim 1, further comprising:
a table on which a print object is placed; wherein
the cleaner assembly is detachably attached to the table; and
the conveyor moves the ink head and the cleaner assembly relative to each other by moving the ink head and the table relative to each other with the cleaner assembly attached to the table.
